(19) United States
(12) Patent Application Publication
(10) Pub. No.: US 2011/0156294 A1
(43) Pub. Date: Jun. 30, 2011

(54) METHOD OF MANUFACTURING BRIGHTNESS ENHANCEMENT FILM AND ROLLER USED THEREIN

(75) Inventors: TAI-CHERNG YU, Tu-Cheng (TW); HSIANG-HUNG CHEN, Tu-Cheng (TW)

(73) Assignee: HON HAI PRECISION INDUSTRY CO., LTD., Tu-Cheng (TW)

(21) Appl. No.: 12/757,015

(22) Filed: Apr. 8, 2010

(30) Foreign Application Priority Data
Dec. 24, 2009 (TW) 98144654

(51) Int. Cl. B29D 11/00; B28B 11/08

(52) U.S. Cl. 264/2.1; 425/385

(57) ABSTRACT

A method of manufacturing a brightness enhancement film utilizes a roller with an outer surface and a plurality of slot portions formed thereon by sandblasting and includes heating a substrate, rolling the textured roller on to the substrate such that the slot portions imprint the substrate and form a plurality of protrusions thereon, and cutting the substrate which has been imprinted to provide a brightness enhancement film.

### BACKGROUND

1. Technical Field

The present disclosure generally relates to a method of manufacturing brightness enhancement film and a roller used in the method.

2. Description of Related Art

Backlight modules are critical components of a liquid crystal display, such as that used in a phone or digital camera. A commonly used backlight module often includes brightness enhancement film to optimize optical properties. A roll-to-roll process providing enhanced manufacturing efficiency and lower manufacturing cost is often employed accordingly. A roller for embossing or imprinting arrays of structural features, such as a plurality of micro-structures, is applied to a flexible sheet or film, in this case to imprint or emboss a plurality of micro-structures thereon. A new flexible substrate, or film can be rolled for a subsequent imprint, or the rolled flexible sheet or film can be cut to a requisite size and shape. However, the micro-structures, often formed by machining or etching, can lead to having more complicated arrangements, processes with increased costs, and also added complexity for such methods.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a roller utilized in a method of manufacturing a brightness enhancement film before sandblasting.

FIG. 2 is an isometric view of the roller of FIG. 1 after sandblasting.

FIG. 3 shows the roller of FIG. 2 imprinting a substrate.

FIG. 4 is an isometric view of a brightness enhancement film formed by the roller of FIG. 2.

FIG. 5 is a flowchart of a method of manufacturing the brightness enhancement film, performed by a roller such as, for example, that of FIG. 4.

### DETAILED DESCRIPTION

A method of manufacturing a brightness enhancement film is described in the following.

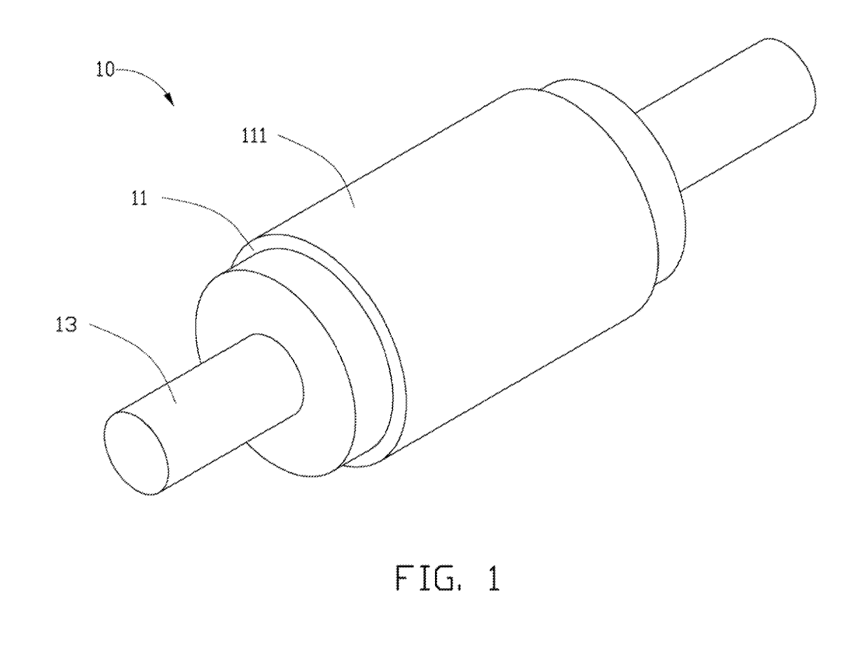

Referring to FIG. 1, a roller 10 is provided. The roller 10 includes a main body 11 and two spindles 13 extending from opposite ends of the main body 11. The main body 11 is a roller, and includes an outer surface 111. The roller 10 is made of a metallic material providing superior heat conduction, such as aluminum, copper, zinc, nickel, iron, titanium, cobalt, an alloy thereof, or stainless steel.

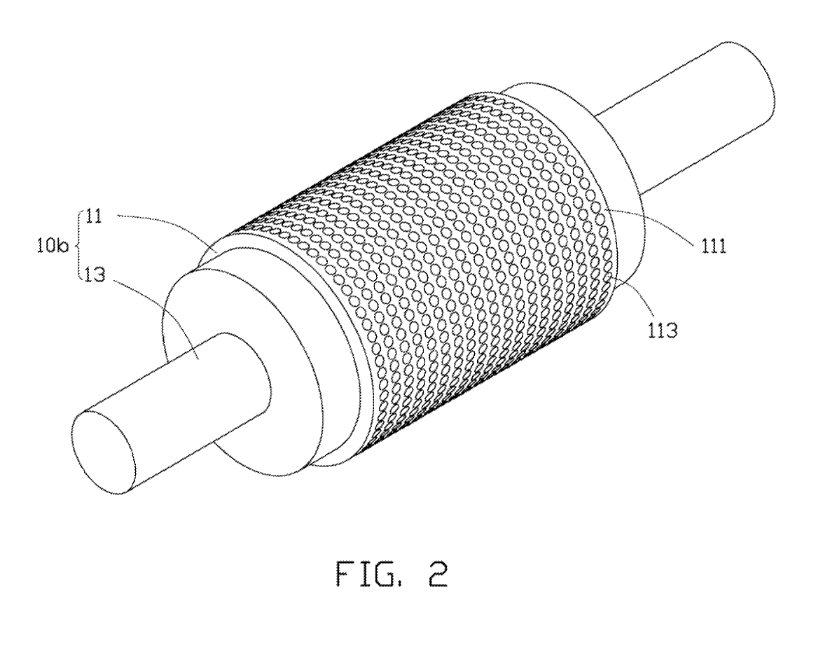

Referring to FIG. 2, a textured roller 10b is formed using a sandblasting device (not shown). A plurality of slot portions 113 are defined in the outer surface 111 by sandblasting thereon. The velocity and pressure of the sandblasting device during sandblasting can be adjusted according to the different desired quantities and distributions of the slot portions 113 so as to acquire a desired roughness. For better results, the sand used (not shown) should provide improved rigidity, such as that of the glass sand. The slot portions 113 may comprise any hollow structure, such as, in the illustrated embodiment, a plurality of hemispherical slots. The slot portions 113 may be directly defined in the outer surface 111, or alternatively be defined in a sheet (not shown) and then adhered to the outer surface 111 of the roller 10.

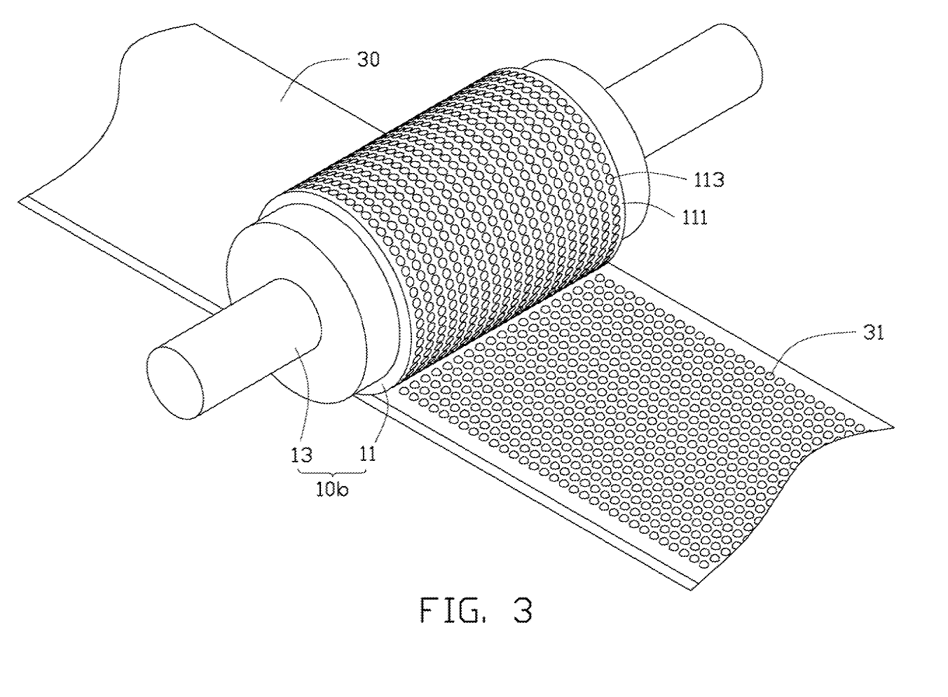

Referring to FIG. 3, a substrate 30 is provided. The substrate 30 may be a film, a flexible sheet, or other flexible material. The substrate 30 can be delivered by an automatic transport device (not shown).

To enhance the embossing effect, the delivered substrate 30 is heated, and the textured roller 10b is applied to the substrate 30, whereby the micro-structures 113 form a plurality of protrusions 31. In the illustrated embodiment, the protrusions 31 are hemispherical protrusions.

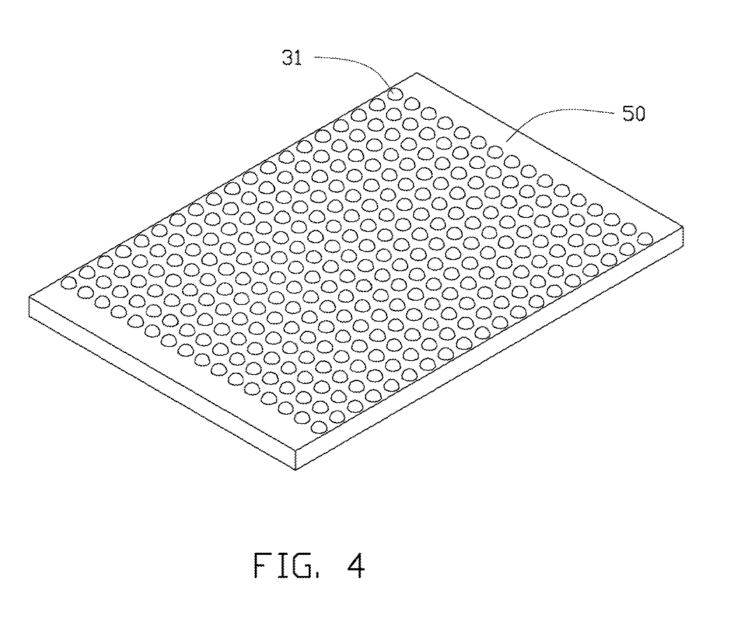

Referring to FIGS. 3 and 4, the substrate 30, which includes the protrusions 31 thereon, is then cut to achieve the desired dimensions of at least one brightness enhancement film 50.

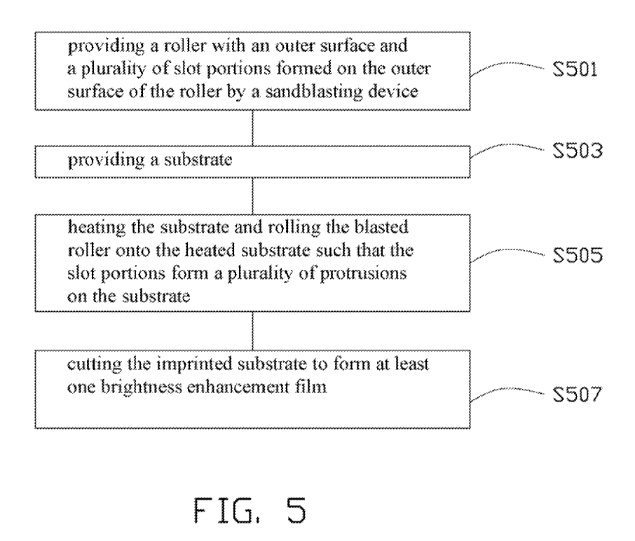

FIG. 5 is a flowchart of a method of manufacturing the brightness enhancement film performed by using a roller such as, for example, that of FIG. 4, as follows. In step S501, a roller 10 is provided; and the roller 10 has an outer surface 111 and a plurality of slot portions 113 formed thereon by sandblasting. In step S503, a substrate 30 is provided. In step S505, the substrate 30 is heated; and the textured roller 10b is rolled onto the heated substrate 30, whereby the slot portions 113 form a plurality of protrusions 31 thereon.

The slot portions 113 of the roller 10b can be formed by sandblasting performed directly, in which case there is no need to trim the materials from the roller 10b. Furthermore, after the slot portions 113 are formed, no further machining or post-processing of the roller 10b is required, thereby reducing manufacturing costs.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A method of manufacturing a brightness enhancement film, comprising:
providing a roller having an outer surface and a plurality of slot portions formed on the outer surface of the roller by sandblasting;
providing a substrate;
heating the substrate and rolling the blasted roller onto the heated substrate such that the slot portions form a plurality of protrusions on the substrate; and
cutting the substrate to form at least one brightness enhancement film.

2. The method of manufacturing a brightness enhancement film of claim 1, wherein the slot portions of the roller are a plurality of hemispherical slots.

3. The method of manufacturing a brightness enhancement film of claim 1, wherein the sand used for sandblasting of the roller is glass sand.

4. The method of manufacturing a brightness enhancement film of claim 1, wherein the roller is made of metallic material.

5. The method of manufacturing a brightness enhancement film of claim 4, wherein the roller is made of aluminum, copper, zinc, nickel, iron, titanium, cobalt, or an alloy thereof.

6. The method of manufacturing a brightness enhancement film of claim 4, wherein the roller is made of stainless steel.

7. The method of manufacturing a brightness enhancement film of claim 1, wherein the substrate is a film.

8. The method of manufacturing a brightness enhancement film of claim 1, wherein the substrate is a flexible sheet.

9. A roller, comprising:
an outer surface having a plurality of micro-structures formed thereon;
wherein the outer surface of the roller further comprises a plurality of slot portions formed by sandblasting.

10. The roller of claim 9, wherein the roller comprises a main body and two spindles extending from the opposite ends of the main body.

11. The roller of claim 9, wherein the roller is made of metallic material.

12. The roller of claim 11 wherein the roller is made of aluminum, copper, zinc, nickel, iron, titanium, cobalt, or an alloy thereof.

13. The roller of claim 11 wherein the roller is made of stainless steel.
